(19) United States
(12) Patent Application Publication
(10) Pub. No.: US 2002/0050783 A1
(43) Pub. Date: May 2, 2002

(54) Electromagnetic-wave-shielding film, production method thereof and image display device using the same

(76) Inventors: Tadahiko Kubota, Minami-ashigara-shi (JP); Takumi Ando, Minami-ashigara-shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/870,823

(22) Filed: Jun. 1, 2001

(30) Foreign Application Priority Data
Jun. 1, 2000 (JP) 2000-165073
Jul. 19, 2000 (JP) 2000-219720

(51) Int. Cl. H01J 1/62; H01J 63/04

(52) U.S. Cl. 313/495; 313/110; 313/635

(57) ABSTRACT

An electromagnetic-wave-shielding film, which has a transparent support and a conductive layer composed of a metal thin film, the conductive layer being composed of a mesh film in which random mesh portions are formed. An image display device, wherein the electromagnetic-wave-shielding film is mounted.

### FIELD OF THE INVENTION

The present invention relates to an electromagnetic-wave-shielding film, having a transparent support and a layer with a rough (uneven) surface, and a method of producing the same. Specifically, the present invention relates to an electromagnetic-wave-shielding film mounted on an image display device, such as a plasma display panel (PDP), a liquid crystal display device (LCD), an electroluminescence display (ELD), a fluorescence display tube, and a field emission-type display, in order to prevent light from outside from being reflected on the image display device.

### BACKGROUND OF THE INVENTION

In such an image display device as a plasma display panel (PDP), a liquid crystal display device (LCD), an electroluminescence display (ELD), a cathode-ray-tube display device (CRT), a fluorescence display tube, and a field emission-type display, the display surface thereof is originally flat, or at least attempts are being made to modify it to the flat-panel type. By modifying the display surface to the flat-panel type, distortion of end portions of the display is decreased. In this case, however, the problem that light from outside is reflected on the display surface still remains unsolved. This problem is becoming more serious, because the size of displays is becoming larger nowadays. Further, in the image display devices described above, a color image is displayed by combining the three primary colors of red, blue, and green. Here, however, obtaining light for display that provides the three primary colors ideally is very difficult (substantially impossible). For example, in the case of a plasma display panel (PDP), it is known that light emitted from a three-primary-color fluorescence light emitting body contains unnecessary light (i.e. light having a wavelength in the range of 500 to 620 nm).

Therefore, conducting color correction has been proposed, in which a filter that absorbs light of specific wavelength is used to correct the color balance of displayed colors. Publications disclosing color correction by a filter include JP-A-58-153904 (“JP-A” means unexamined published Japanese patent application), JP-A-61-188501, JP-A-3-231988, JP-A-5-205643, JP-A-9-145918, JP-A-9-306366, and JP-A-10-26704.

Further, as an electronic display, such as a PDP, LCD, ELD, and CRT, radiates electromagnetic waves from the display surface thereof, there must be provided a means for shielding the electromagnetic waves. As a method of shielding electromagnetic waves, it is known that the method of mounting (laminating) a metal mesh film on the front panel of a CRT achieves a high electromagnetic-wave-shielding property. References that disclose this method include JP-A-62-150282, JP-A-4-48507, JP-A-10-75087, JP-A-11-119669, and JP-A-11-204046. However, although this method is effective in blocking electromagnetic waves, there arises the problem, in this method, that geometrical patterns formed by pixels of the display, and those formed by the mesh film, interfere with each other, causing a phenomenon called “moire.”

In addition, another problem reported is that the remote control device may operate incorrectly due to the action of the infrared rays (mainly in the range of 750 to 1100 nm) generated from the display. To solve this problem, an infrared absorbing filter has been used. A publication (U.S. Pat. No. 5,945,209) gives some description of the dye to be used in the infrared absorbing filter, which is, however, far from a satisfactory solution of the aforementioned problem.

### SUMMARY OF THE INVENTION

The present invention is an electromagnetic-wave-shielding film, which has a transparent support and a conductive layer composed of a metal thin film, wherein the conductive layer is composed of a mesh film in which random mesh portions are formed.

Further, the present invention is a method of producing an electromagnetic-wave-shielding film having a transparent support and a conductive layer composed of a metal thin film, which method comprises the step of:

forming the conductive layer by using a mesh film in which random mesh portions are formed.

Still further, the present invention is an image display device, wherein an electromagnetic-wave-shielding film, having a transparent support and a conductive layer composed of a metal thin film, is mounted on a front surface of the device, the conductive layer being composed of a mesh film in which random mesh portions are formed.

Other and further features, and advantages of the invention will appear more fully from the following description, taken in connection with the accompanying drawings.

### BRIEF DESCRIPTION OF THE DRAWINGS

FIG. 1 is a schematic view showing one embodiment of a mesh film composed of a metal thin film.

FIG. 2 is a schematic view showing another embodiment of a mesh film composed of a metal thin film.

FIG. 3 is a schematic view showing yet another embodiment of a mesh film composed of a metal thin film.

FIG. 4 is a schematic view showing still another embodiment of a mesh film composed of a metal thin film.

FIG. 5 is a schematic view showing further another embodiment of a mesh film composed of a metal thin film.

FIG. 6 is an explanatory view of a preferable embodiment of the random mesh pattern formation in the present invention.

FIG. 7 is an explanatory view of another preferable embodiment of the random mesh pattern formation in the present invention.

FIG. 8 is a sectional view showing a preferable embodiment of the electromagnetic-wave-shielding film of the present invention.

FIG. 9 is a schematic view showing a random mesh pattern of a photomask employed in Example 2-1.

### DETAILED DESCRIPTION OF THE INVENTION

According to the present invention, there are provided the following means:

(1) An electromagnetic-wave-shielding film, having a transparent support and a conductive layer composed of a metal thin film, wherein the conductive layer is composed of a mesh film in which random mesh portions are formed.

(2) The electromagnetic-wave-shielding film as described in the above (1), wherein a shape of the random mesh portions formed in the conductor layer is formed by intersecting points obtainable by shifting lattice lines of a regular lattice pattern from the original position thereof.

(3) The electromagnetic-wave-shielding film as described in the above (2), wherein a range within which the intersecting points of the lattice lines of the random mesh pattern are arranged, is located within an area defined by linking middle points between an individual intersecting point and each adjacent point thereof of the regular lattice pattern before shifting the lattice lines.

(4) The electromagnetic-wave-shielding film as described in the above (1), wherein the mesh film formed by the metal thin film is formed by etching according to a photolithography method.

(5) The electromagnetic-wave-shielding film as described in the above (1), whose lines which form the random mesh shape each have a width of 15 μm or less.

(6) The electromagnetic-wave-shielding film as described in the above (1), whose lines which form the random mesh shape each have a thickness in the range of 0.1 to 10 μm

(7) The electromagnetic-wave-shielding film as described in the above (1), wherein a unit space area of the mesh formed by the metal thin film is two fifths or less of a pixel area of an image display device.

(8) The electromagnetic-wave-shielding film as described in the above (1), whose surface is being subjected to blackening.

(9) The electromagnetic-wave-shielding film as described in the above (1), in which an infrared-ray cutting layer containing a dye that absorbs light in an infrared-ray range, is formed.

(10) The electromagnetic-wave-shielding film as described in the above (9), in which a visible-light absorbing layer containing a dye that absorbs light in a visible-light range is formed.

(11) A method of producing an electromagnetic-wave-shielding film having a transparent support and a conductive layer composed of a metal thin film, comprising the step of:

forming the conductive layer by using a mesh film in which random mesh portions are formed.

(12) The method as described in the above (11), comprising forming the random mesh portions to be formed in the conductive layer, by using a shape formed by intersecting points obtainable by shifting lattice lines of a regular lattice pattern from the original position thereof.

(13) The method as described in the above (11), comprising forming the mesh film formed by the metal thin film, by electroless plating.

(14) The method as described in the above (11), comprising forming the mesh film formed by the metal thin film, by etching according to a photolithography method.

(15) An image display device, wherein an electromagnetic-wave-shielding film, having a transparent support and a conductive layer composed of a metal thin film, is mounted on a front surface of the device, the conductive layer being composed of a mesh film in which random mesh portions are formed.

(16) The image display device as described in the above (15), wherein the electromagnetic-wave-shielding film mounted on the front surface, has a unit space area of the mesh formed by the metal thin film of two fifths or less of a pixel area of the image display device, and has the random mesh portions in the conductive layer, which are formed by intersecting points obtainable by shifting lattice lines of a regular lattice pattern from the original position thereof.

(17) The image display device as described in the above (15), wherein the electromagnetic-wave-shielding film mounted on the front surface, has an infrared-ray cutting layer containing a dye that absorbs light in an infrared-ray range, in the film.

(18) The image display device as described in the above (15), which is a plasma display panel, wherein the electromagnetic-wave-shielding film is mounted on the front surface thereof.

A preferred embodiment of the present invention will be described hereinafter, but the present invention is not limited to these.

The electromagnetic-wave-shielding film having a transparent support and a mesh film composed of a metal thin film of the present invention may be used by mounting the electromagnetic-wave-shielding film on an image display device, for example on a plasma display. From the viewpoint of preventing moire or the like from occurring, the electromagnetic-wave-shielding film is preferably mounted on the image display device directly.

When the electromagnetic-wave-shielding film is mounted on the plasma display, it is preferable that an adhesive agent is used for adhesion. Herein, the adhesive agent represents an adhesive material having rubber-like stickiness. Examples of a preferable adhesive agent include natural rubber-series, SBR-series, butyl rubber-series, recycled rubber-series, acryl-series, polyisobutylene-series, silicone rubber-series adhesive agents, and polyvinyl butyl ether. Among the aforementioned examples, acryl-series adhesives are more preferably used.

With respect to the adhesive agent, those described in “Kokino Secchakuzai• Nenchakuzai” (High performance Adhesives) edited by The Society of Polymer Science, Japan (Kobunshi-Gakkai) and other publications can be used.

The adhesive layer is obtained by directly coating and drying a coating solution in which the adhesive agent described above is dissolved or dispersed in water or a solvent. Alternatively, the adhesive layer can be provided by laminating a structure in which an adhesive layer has been formed in advance on a support composed of polyethylene terephthalate (PET) or the like having excellent peeling property.

In the formation of the metal thin film for use in the present invention, a mesh film formed by the metal thin film may be formed, by etching, according to a photolithography method, after forming the metal thin film on a transparent support. Specifically, the mesh film can be produced, for example, by: coating a photosensitive resin on the transparent support; providing a mask having a predetermined shape on the coating; subjecting the masked coating to exposure to light and development, thereby forming a resist layer; and removing, by etching, the portion which is not covered by the resist. The thin film is preferably formed by a method of laminating metal foils, an electrolytic plating method, an electroless plating method, a vapor deposition method, a spattering method, an ion plating method, or the like, and more preferably formed by an electroless plating method, or a method in which electrolytic plating is performed after electroless plating.

The line width of the mesh composed of a metal thin film for use in the present invention is preferably 15 μm or less, more preferably 9 μm or less, and particularly preferably 7 μm or less.

Preferable examples of the metal to be used for a material of the metal thin film include gold, silver, copper, platinum, nickel, chromium, tin, rhodium, iridium, and palladium. More preferable examples thereof include gold, silver, copper, nickel, chromium, tin, and palladium, and particularly preferable examples thereof include copper, nickel and tin. These metals may be used solely or in combination of two or more than two types of these. When two or more than two types of the metals are used in combination, the metals may be used as an alloy or may be separately laminated one over another. The preferable combination of the metals is copper and nickel.

The electromagnetic-wave-shielding film (optical filter) having a mesh film composed of a metal thin film of the present invention can be used by mounting the electromagnetic-wave-shielding film, preferably mounting it directly, on an image display device, such as a plasma display. Here, the unit space area of the mesh (the area defined by the lines which constitute the mesh) is preferably two fifths or less of the pixel area of the image display device, more preferably no larger than one eighths of the pixel area of the image display device, and particularly preferably no larger than one tenths of the pixel area of the image display device. In a case in which plural different unit space areas are present, “the unit space area” means the average of the plural different unit space areas. In a case of the combination of shapes for the random mesh portions, the average area thereof is to be within the aforementioned range.

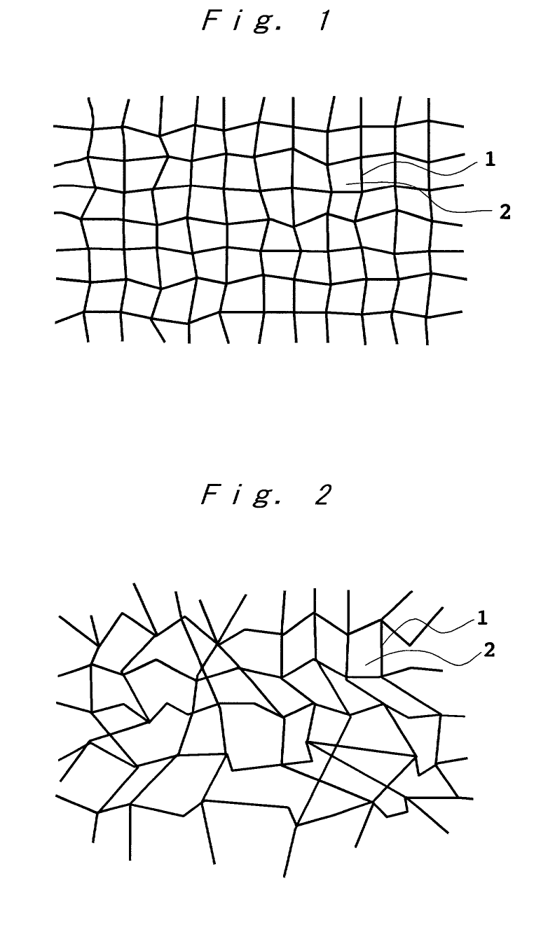

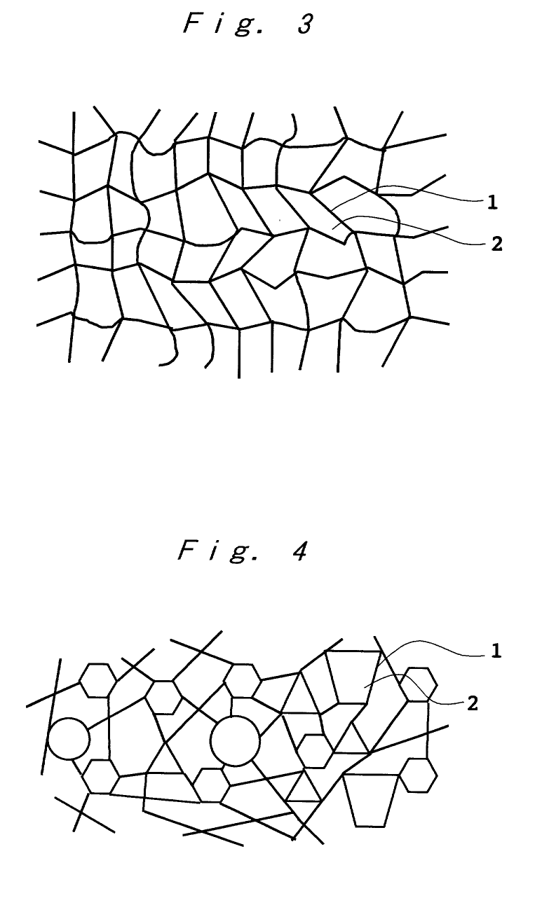

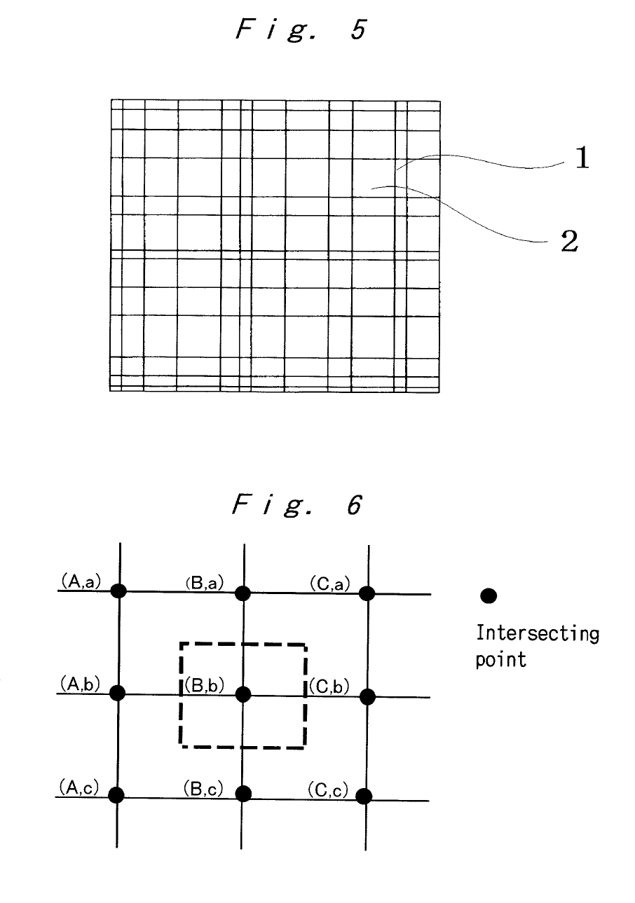

Examples of the shape of the unit space include, with no limitation to these examples, square, rectangle, quadrilateral other than square and rectangle, regular pentagon, pentagon, regular hexagon, hexagon, circle and ellipsoidal. In a case in which plural unit spaces are combined so as to form a larger plane, as the pattern of combination, the unit spaces having the same shape may be combined as shown in FIGS. 1 to 4 or the unit spaces having different shapes may be combined at random. In general, combining the unit spaces having different shapes at random is preferable. Alternatively, a random lattice-like mesh pattern in which parallel lines having random intervals therebetween are combined as shown in FIG. 5 may be used. The intervals between the parallel lines may be all at random or may be set regularly in some portions. In the drawings, the reference number 1 represents a metal line of the mesh and 2 represents a net-like (mesh) structure.

In a case in which an electromagnetic-wave-shielding film (filter) for a large-sized display is produced, a plurality of the aforementioned films may be used in combination.

The thickness of the metal lines of the mesh formed by a metal film (such metal lines will be referred to simply as “the metal lines” hereinafter) is preferably in the range of 0.1 μm to 10 μm, more preferably in the range of 1 μm to 7 μm, and particularly preferably in the range of 1 μm to 5 μm.

Further, the metal lines may be subjected to blackening by carrying out etching after forming a black resist on the metal thin film.

The opening rate of the mesh film is preferably 60% or more, more preferably 75% or more and particularly preferably 85% or more.

A random mesh shape in the mesh film can preferably be formed by designing a photomask such that intersecting points in the mesh film are arranged at random by shifting the lattice lines of the photomask in a predetermined range with respect to the regularly-arranged lattice pattern. It should be noted that, although the re-arrangement of the intersecting points by shifting may be carried out at random, such a re-arrangement is preferably carried out in a predetermined range.

The range in which an intersecting point may be shifted is preferably within the range defined by linking the points each located, from the intersecting point, within four fifths of the distance between the intersecting point and an individual adjacent point thereof in the regular lattice before shifting, more preferably within the range defined by linking the points each located, from the intersecting point, one fifth to four fifths of the distance between the intersecting point and an individual adjacent point thereof in the regular lattice before shifting, and particularly preferably within an area defined by linking the middle points between the intersecting point and an individual adjacent point thereof in the regular lattice before shifting. Alternatively, an intersecting point can preferably be shifted within a circle, whose center is the intersecting point and whose radius is defined as a half of the distance between the intersecting point and the closest adjacent point in the regular lattice before shifting.

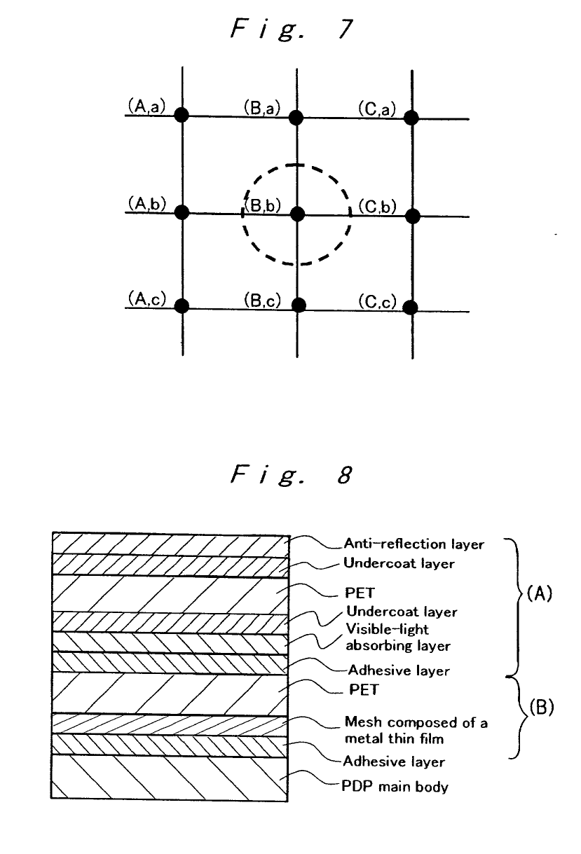

FIG. 6 and FIG. 7 show examples of the range in which the intersecting points are arranged at random. FIG. 6 represents a preferable embodiment, which is an example of defining the range by linking the middle points between the intersecting point and each adjacent point. In both of these drawings, the range within the dotted line represents the range in which the intersecting point can be re-arranged.

FIG. 6 shows the intersecting points before shifting and the range within which the coordinate (B, b) that is one of the intersecting points before shifting can be re-arranged by shifting (which range is the portion defined by the broken line). The coordinates of the broken-line portion are ((A+B)/2, (a+b)/2), ((B+C)/2, (a+b)/2), ((A+B)/2, (b+c)/2), and ((B+C)/2, (b+c)/2).

FIG. 7 represents another preferable embodiment, which shows the intersecting points before shifting and the range within which the coordinate (B, b) that is one of the intersecting points before shifting can be re-arranged by shifting (which range is the portion defined by the broken line). The broken-line portion defines a circle having a radius of (a+b)/2 in this case.

By carrying out re-arrangement by shifting of the intersecting points within the aforementioned range and linking the re-arranged intersecting points, a random mesh shape can be formed.

By forming the random mesh pattern by shifting the lattice lines, the problem of moire can be solved. This is because the number of intersecting points in a given area is not changed due to the shifting of the lattice lines, thereby electromagnetic-wave-shielding property is maintained uniformly on the mesh pattern surface after said shifting.

A layer having infrared-ray shielding effect (an infrared-ray shielding layer) may be provided on the electromagnetic-wave-shielding film.

The infrared-ray shielding layer preferably has a shielding effect for near infrared-ray having a wavelength of 800 to 1200 nm. The infrared-ray shielding layer can be composed of a resin mixture. Examples of the infrared-ray shielding component to be contained in the resin mixture that can be used include copper (as described in JP-A-6-118228), a copper compound or a phosphorus compound (as described in JP-A-62-5190), a copper compound or a thiourea compound (as described in JP-A-6-73197) or a tungsten compound (U.S. Pat. No. 3,647,772). Alternatively, instead of providing the infrared-ray shielding layer, a resin mixture may be added to the transparent support.

The film of the present invention preferably exhibits maximum light absorption in the ranges of 750 to 850 nm, 851 to 950 nm and 951 to 1100 nm, more preferably in the ranges of 790 to 845 nm, 860 to 945 nm and 960 to 1050 nm, and most preferably in the ranges of 800 to 840 nm, 870 to 940 nm and 970 to 1030 nm. The transmittance of the film in the aforementioned wavelength ranges of the maximum absorption is generally between 0.01 and 30% in each range, preferably between 0.05 and 20% in each range, and most preferably between 0.1 and 10% in each range.

In the present invention, in order to provide the aforementioned absorption spectra, a filter can be formed by using a dye (a dyestuff or a pigment).

The absorption spectra of the dye exhibiting the maximum absorption in the above wavelength range of 750 to 1100 nm preferably has a sub-absorption in the range of visible light (400 to 700 nm) as small as possible, so that the brightness of the fluorescent body is not decreased. In order to obtain a preferable wave shape of absorption, it is especially preferable to employ a dye in the state of association.

A dye in the state of association exhibits a sharp absorption spectrum peak because the dye forms a so-called “J-band”. With respect to the association of dyes and J-band thereof, detailed descriptions can be found in some literatures (e.g., “Photographic Science and Engineering” Vol. 18, No 323-335 (1974)). The maximum absorption of a dye in the state of J-association is shifted toward the longer wavelength side, as compared with the maximum absorption of a dye in the state of a solution. Accordingly, determination of whether the dye contained in the filter layer is in the state of association or not can be easily done by measuring the maximum absorption.

In the present specification, the state, in which the maximum absorption has been shifted toward the longer wavelength side by 30 nm or more as compared with the maximum absorption of the dye in the state of a solution, will be referred to as “the state of association. The dye in the state of association preferably exhibits the shift of maximum absorption of 30 nm or more, more preferably 40 nm or more, and most preferably 45 nm or more.

Some dye compounds proceed to the state of association simply by being dissolved in water. However, in general, the associated product of a dye can be formed by adding gelatin or a salt (e.g., barium chloride, potassium chloride, sodium chloride and calcium chloride) to an aqueous solution of the dye. The method of adding gelatin to the aqueous solution of the dye is especially preferable.

The associated product of a dye may be formed as a dispersion of solid fine-particles of the dye. In order to obtain the dispersion of solid fine-particles, a known dispersion device can be used. Examples of such a dispersion device include ball mill, vibration ball mill, planetary ball mill, sand mill, colloid mill, jet mill and roller mill. JP-A-52-92716 and WO88/074794 disclose such dispersion devices. It is preferable to employ a medium dispersion device of upright or lateral type.

The dispersion described above may be carried out under the presence of an appropriate medium (e.g., water, an alcohol). It is preferable that a surfactant for dispersion is used together. As the surfactant for dispersion, an anionic surfactant (as disclosed in JP-A-52-92716 and WO88/074794) is preferably used. An anionic polymer, a nonionic surfactant or a cationic surfactant may optionally be used.

Powder in the fine-particle state can be obtained by dissolving the dye in an appropriate solvent and then adding a poor solvent thereto. The aforementioned surfactant for dispersion may be used in this case, as well. Alternatively, microcrystals of the dye can be deposited by dissolving the dye in a solvent by adjusting the pH value of the solution and then changing the pH. The microcrystals thus obtained are also composed of the associated product of the dye.

In a case in which the dye in the state of association is fine-particles (or microcrystals), the average particle diameter is preferably in the range of 0.01 to 10 μm.

Preferable examples of the dye used in the state of association include methine dyes (e.g., cyanine, merocyanine, oxonol, styryl). The most preferable examples thereof include a cyanine dye or an oxonol dye.

The preferable cyanine dye is defined by the following formula:

Bs=Lo−Bo

wherein Bs represents a basic nucleus, Bo represents an onium form of the basic nucleus, and Lo represents a methine chain constituted of an odd number of methines.

Further, the cyanine dye represented by the following formula (1) can be preferably used, especially in the state of association.

[chemical structure]

In formula (1), Z¹ and Z² each independently represent a group of non-metal atom(s) necessary to complete a 5- or 6-membered nitrogen-containing heterocycle. Another heterocycle, aromatic ring or aliphatic ring may be condensed, to the nitrogen-containing heterocycle Examples of the nitrogen-containing heterocycle and the condensed ring include an oxazole ring, an isoxazole ring, a benzoxazole ring, a naphthoxazole ring, an oxazolocarbazole ring, an oxazolodibenzofuran ring, a thiazole ring, a benzothiazole ring, a naphthothiazole ring, an indolenine ring, a benzoindolenine ring, an imidazole ring, a benzoimidazole ring, a naphthoimidazole ring, a quinoline ring, a pyridine ring, a pyrrolopyridine ring, a furopyrrole ring, an indolizine ring, an imidazoquinoxaline ring, a quinoxaline ring, and the like. As the nitrogen-containing heterocycle, a 5-membered ring is more preferable than a 6-membered ring. A 5-membered nitrogen-containing heterocycle to which a benzene ring or a naphthalene ring is condensed is further more preferable. Specifically, a benzothiazole ring, a naphthothiazole ring, an indolenine ring or a benzoindolenine ring are preferable.

The nitrogen-containing heterocycle and the ring condensed thereto may have a substituent. Examples of the substituent include a halogen atom, a cyano group, a nitro group, an aliphatic group, an aromatic group, a heterocyclic group, —OR¹⁰, —COR¹¹, —COOR¹², —OCOR¹³, —NR¹⁴R¹⁵, —NHCOR¹⁶, —CONR¹⁷R¹⁸, —NHCONR¹⁹R²⁰, —NHCOOR²¹, —SR²², —SO₂R²³, —SO₂OR²⁴, —NHSO₂R²⁵ or —SO₂NR²⁶R²⁷. R¹⁰ to R²⁷ each independently represent a hydrogen atom, an aliphatic group, an aromatic group or a heterocyclic group. In a case in which R¹² of —COOR¹² is a hydrogen atom (i.e., a carboxyl group) and in a case in which R²⁴ of —SO₂OR²⁴ is a hydrogen atom (i.e., a sulfo group), the hydrogen atom in each case may be dissociated or the group may be in the state of a salt.

In the present invention, the aliphatic group represents an alkyl group, an alkenyl group, an alkynyl group or an aralkyl group. These groups each may have a substituent.

The alkyl group may be either a cycloalkyl group or a chain-alkyl group. The chain-like alkyl group may be branched. The number of carbon atoms of the alkyl group is preferably 1 to 20, more preferably 1 to 12, and most preferably 1 to 8. Examples of the alkyl group include methyl, ethyl, propyl, isopropyl, butyl, t-butyl, cyclopropyl, cyclohexyl and 2-ethylhexyl.

The alkyl moiety of the substituted alkyl group has the same meaning as that of the aforementioned alkyl group. The substituent in the substituted alkyl group has the same meaning as the substituent on the nitrogen-containing heterocycle of Z¹ and Z² (however, the cyano group and the nitro group are excluded). Examples of the substituted alkyl group include 2-hydroxyethyl, 2-carboxyethyl, 2-methoxyethyl, 2-diethylaminoethyl, 3-sulfopropyl and 4-sulfobutyl.

The alkenyl group may be either cyclic or chain. The chain-like alkenyl group may be branched. The number of carbon atoms of the alkenyl group is preferably 2 to 20, more preferably 2 to 12, and most preferably 2 to 8. Examples of the alkenyl group include vinyl, allyl, 1-propenyl, 2-butenyl, 2-pentenyl, and 2-hexenyl.

The alkenyl moiety of the substituted alkenyl group has same meaning as that of the aforementioned alkenyl group. The substituent in the substituted alkenyl group has the same meaning as the substituent of the alkyl group.

The alkynyl group may be either cyclic or chain. The chain-like alkynyl group may be branched. The number of carbon atoms of the alkynyl group is preferably 2 to 20, more preferably 2 to 12, and most preferably 2 to 8. Examples of the alkynyl group include ethinyl and 2-propynyl.

The alkynyl moiety of the substituted alkynyl group has the same meaning as that of the aforementioned alkynyl group. The substituent in the substituted alkynyl group has the same meaning as the substituent of the alkyl group.

The alkyl moiety of the aralkyl group has the same meaning as that of the aforementioned alkyl group. The aryl moiety of the aralkyl group is has the same meaning as the aryl group described below. Examples of the aralkyl group include benzyl and phenethyl.

The aralkyl moiety of the substituted aralkyl group has the same meaning as that of the aforementioned aralkyl group. The aryl moiety of the substituted aralkyl group has the same meaning as that of the aryl group described below.

In the present invention, the aromatic group means an unsubstituted aryl group or a substituted aryl group.

The number of carbon atoms of the aryl group is preferably 6 to 25, more preferably 6 to 15, and most preferably 6 to 10. Examples of the aryl group include phenyl and naphthyl.

Examples of the substituent of the substituted aryl group have the same meanings as those of the substituent of the nitrogen-containing heterocycle of Z¹ and Z². Examples of the substituted aryl group include 4-carboxyphenyl, 4-acetoamidophenyl, 3-methanesulfoneamidophenyl, 4-methoxyphenyl, 3-carboxyphenyl, 3,5-dicarboxyphenyl, 4-methanesulfoneamidophenyl and 4-butanesulfoneamidophenyl.

In the present invention, the heterocyclic group may have a substituent. It is preferable that the heterocycle of the heterocyclic group is a 5- or 6-membered ring. The heterocycle may have an aliphatic ring or an aromatic ring or another heterocyclic ring condensed thereto. Examples of the heterocycle (including the condensed ring) include a pyridine ring, a pyperidine ring, a furan ring, a furfran ring, a thiophene ring, a pyrrole ring, a quinoline ring, a morpholine ring, an indole ring, an imidazole ring, a pyrazole ring, a carbazole ring, a phenothiazine ring, a phenoxazine ring, an indoline ring, a thiazole ring, a pyrazine ring, a thiadiazine ring, a benzoquinoline ring and a thiadiazole ring.

The substituent on the heterocycle has the same meaning as the substituent of the nitrogen-containing heterocycle of Z¹ and Z².

The aliphatic group and the aryl group represented by R¹ and R² of the formula (1) have the same meanings as those described above.

L¹ is a methine chain constituted of an odd number (preferably 5 or 7) of methines. The methine group may have a substituent. The methine group having the substituent is preferably the methine group present at the center (i.e., the methine group at the meso position). Examples of the substituent have the same meanings as those of the substituent of the nitrogen-containing heterocycle of Z¹ and Z². Two substituents on a methine chain may bond together, to form a 5- or 6-membered ring.

a, b and c each independently represent 0 or 1. a and b are preferably zero (0). In a case in which the cyanine dye has an anionic substituent, such as sulfo or carboxyl, to form an intermolecular salt, c is zero.

X¹ is an anion. Examples of the anion include a halide ion (Cl⁻, Br⁻, I⁻), a p-toluenesulfonic acid ion, an ethylsulfric acid ion, PF₆⁻, BF₄⁻ or ClO₄⁻.

The cyanine dye that can be used in the present invention preferably has a carboxyl group or a sulfo group. Specific examples of the cyanine dye are shown below, but the invention is not limited to these.

[chemical structure]

| Dye | R | R′ |
|---|---|---|
| 1-1 | 6-Cl | —CH₂Ph |
| 1-2 | ″ | 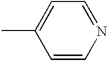 |
| 1-3 | 5-Cl | —CH₃ |
| 1-4 | 5-Ph | ″ |
| 1-5 | ″ | —CH₂Ph |
| 1-6 | 5-CH₃ | H |
| 1-7 | 5,6-di-CH₃ | H |

[chemical structure]

| Dye | R | A |
|---|---|---|
| 1-8 | Cl | 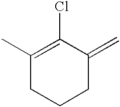 |
| 1-9 | F | 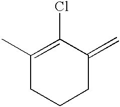 |
| 1-10 | Cl | 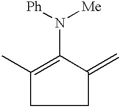 |
| 1-11 | Cl | 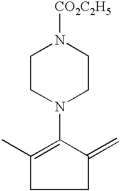 |

[chemical structure]

| Dye | A |
|---|---|
| 1-12 | —CH═CH—CH═ |
| 1-13 | 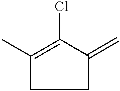 |
| 1-14 | 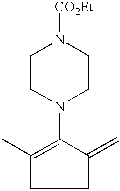 |
| 1-15 | 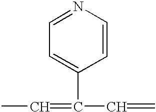 |
| 1-16 | 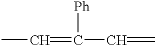 |

[chemical structure]

| | |
|---|---|
| 1-17 | —CH═CH—CH═ |
| 1-18 | 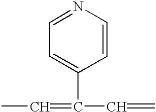 |
| 1-19 | 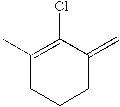 |

[chemical structure]

| Dye | R |
|---|---|
| 1-20 | Cl |
| 1-21 | —SPh |
| 1-22 | —SO₂CH₃ |
| 1-23 | 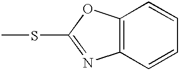 |

The preferable oxonol dye is defined by the following formula.

AK=Lo−Ae

In the formula, Ak represents a keto-type acidic nucleus, Ae represents an enol-type acidic nucleus, and Lo represents a methine chain constituted of an odd number of methine.

The oxonol dye represented by the following formula (2) can be preferably used (especially in the state of association).

Formula (2)

[chemical structure]

In the formula (2), Y¹ and Y² each independently represent a group of non-metal atom(s) necessary to complete an aliphatic ring or a heterocycle. A heterocycle is more preferable than an aliphatic ring. Examples of the aliphatic ring include an indandione ring. Examples of the heterocycle include a 5-pyrazolone ring, an isooxazolone ring, a barbituric acid ring, a pyridone ring, a rhodanine ring, a pyrazolidinedione ring, a pyrazolopyridone ring, and a meldrumic acid ring. The aliphatic ring and the heterocycle each may have a substituent. The substituent has the same meaning as the substituent of the nitrogen-containing heterocycle of Z¹ and Z² described above. Among these, a 5-pyrazolone ring and a barbituric acid ring are preferable.

L² is a methine chain constituted of an odd number of methine. The number of methine is preferably 3, 5 or 7. Among these odd numbers, 5 is most preferable. The methine group may have a substituent. The methine group having a substituent is preferably a methine group located at the center (i.e., a methine group located at the meso position). Examples of the substituent are similar to those of the substituent of the alkyl group described above. Two substituents on a methine chain may bond together, to form a 5- or 6-membered ring.

X² is a hydrogen atom or a cation. Examples of the cation include an alkali metal (e.g., Na, K) ion, an ammonium ion, a triethylammonium ion, a tributylammonium ion, a pyridinium ion and a tetrabutylammonium ion.

Examples of the oxonol dye represented by the formula (2) are shown below, but the invention is not limited to these.

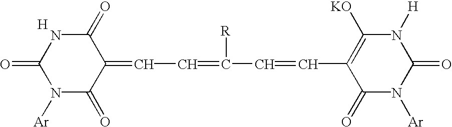

| Dye | Ar | R |
|---|---|---|
| 2-1 | Ph | CH₃ |
| 2-2 | 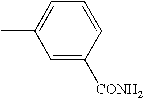 | ″ |
| 2-3 | 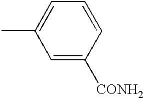 | Ph |
| 2-4 | 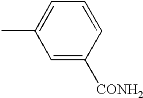 | 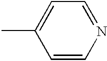 |
| 2-5 | 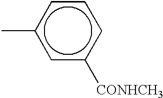 | 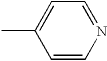 |
| 2-6 | 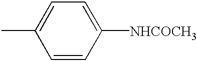 | 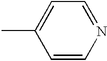 |
| 2-7 | 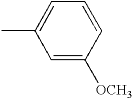 | 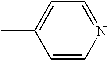 |
| 2-8 | 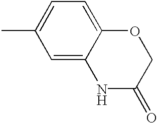 | 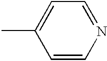 |
| 2-9 | 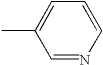 | 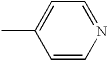 |
| 2-10 | 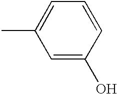 | 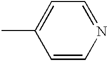 |
| 2-11 | 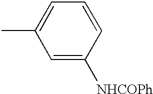 | 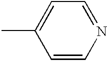 |
| 2-12 | 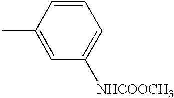 | 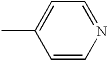 |
| 2-13 | 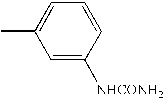 | 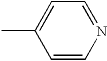 |

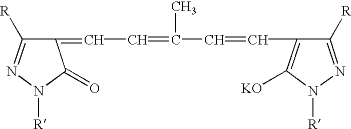

| Compound | R | R′ |
|---|---|---|
| 2-14 | Ph | —CONH₂ |
| 2-15 | C₂H₅ | ″ |
| 2-16 | ″ | —CONHCH₃ |

The oxonol dye of the formula (2) is more preferably used for the range of 750 to 850 nm, while the cyanine dye of the formula (1) is more preferably used for the ranges of 851 to 950 nm and 951 to 1100 nm.

The electromagnetic-wave-shielding film of the present invention is preferably provided with a light absorbing layer which selectively absorbs light having a specific wavelength.

The light absorbing layer preferably exhibits the maximum light absorption (i.e., the minimum transmittance) thereof in the wavelength range of 560 to 620 nm. It is more preferable that the maximum absorption is observed in the wavelength range of 570 to 600 nm, and it is most preferable that the maximum absorption is observed in the wavelength range of 580 to 600 nm. The transmittance observed at the maximum absorption is preferably in the range of 0.01 to 90%, and more preferably in the range of 0.1 to 70%. The wavelength range in which the maximum absorption is effected can be shifted by irradiating light.

The optical filter may also exhibit the maximum light absorption in the wavelength range of 500 to 550 nm, in addition to that in the wavelength range of 560 to 620 nm. The transmittance observed at the maximum absorption in the wavelength range of 500 to 550 nm is preferably in the range of 20 to 85%.

The maximum absorption in the wavelength range of 500 to 550 nm is set in order to adjust the light-emission intensity of the fluorescent body of green light which is high in luminosity factor. It is preferable that the light-emission range of the green-light fluorescent body is cut gradually and gently. The half-value width (the width of the wavelength range between the two wavelengths at each of which the absorbance drops to a half of that observed at the maximum absorption) with respect to the maximum absorption in the wavelength range of 500 to 550 nm is preferably 30 to 300 nm, more preferably 40 to 300 nm, further more preferably 50 to 150 nm, and most preferably 60 to 150 nm.

It is preferable that the maximum absorption in the wavelength range of 560 to 620 nm has a sharp peak of the absorption spectrum thereof, so that light is selectively cut and any influence on light emission of the green-light fluorescent body can be avoided as much as possible. The half-value width at the maximum absorption in the wavelength range of 560 to 620 nm is preferably 5 to 70 nm, more preferably 10 to 50 nm, and most preferably 10 to 30 nm.

In order to provide the aforementioned absorption spectra with the light absorbing layer, it is preferable that a dye (a dyestuff or a pigment) is employed.

Preferable examples of the dye exhibiting the maximum absorption in the wavelength range of 500 to 550 nm that can be used include squarylium dyes, azomethine dyes, cyanine dyes, oxonol dyes, anthraquinone dyes, azo dyes, benzylidene dyes, or pigments produced by lake of these dyes. Examples of the dye exhibiting the maximum absorption in the wavelength range of 500 to 550 nm are shown below, but the invention is not limited to these.

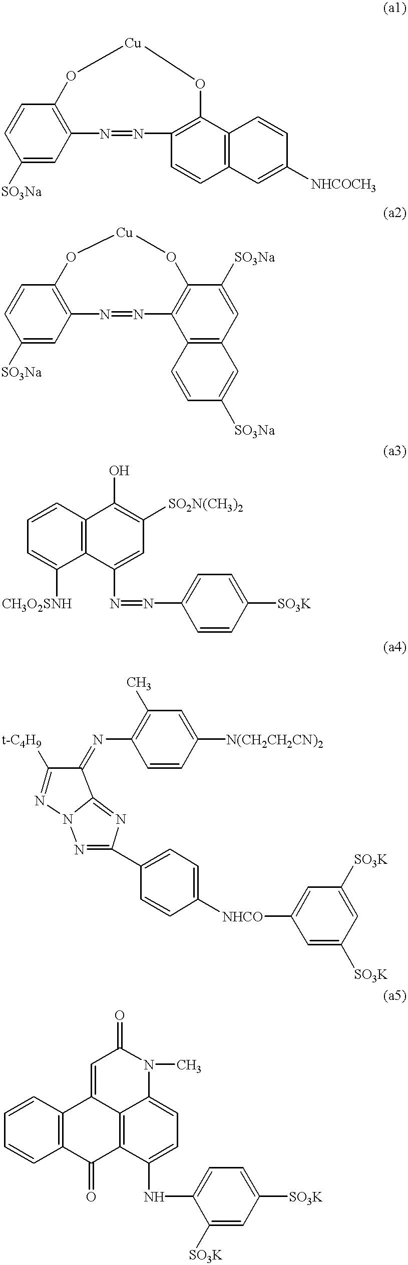

Preferable examples of the dye exhibiting the maximum absorption in the wavelength range of 560 to 620 nm that can be used include cyanine dyes, squarylium dyes, azomethine dyes, xanthene dyes, oxonol dyes, azo dyes, or pigments produced by lake of these dyes. Examples of a dye exhibiting the maximum absorption in the wavelength range of 560 to 620 nm are shown below, but the invention is not limited to these.

[chemical structure]

Further, the film of the present invention preferably exhibits the maximum absorption (i.e., the minimum transmittance) in the wavelength range of 380 to 440 nm. Preferable examples of the dye that has absorption in the wavelength range of 380 to 440 nm include compounds of methine-series, anthraquinone-series, quinone-series, diphenylmethane dyes, triphenylmethane dyes, xanthene dyes, azo-series, azomethine-series. Examples of the methine-series compound include cyanine-series, merocyanine-serries, oxnol-series, arylidene-series and styryl-series compounds.

Two or more than two types of the dyes may be used in combination in the light absorbing layer.

The thickness of the light absorbing layer is preferably 0.1 μm to 5 cm, more preferably 0.5 to 100 μm, and most preferably 1 to 15 μm.

The light absorbing layer can be formed only with the dye. However, in order to control stability and reflectance property of the dye, the light absorbing layer may contain a polymer binder.

As the material for the matrix to be used in the electromagnetic-wave-shielding film and the like of the present invention, gelatin is preferable. Other preferable examples of the matrix to be used include polymers of acryl-series, urethane-series, SBR-series, olefin-series, vinylidene chloride-series, vinyl acetate-series, and polyester-series, and copolymers thereof. With respect to the polymer structure, polymers may be straight-chain or branched. Cross-linked polymers may also be used. With respect to the type of polymers, either homopolymer in which monomers of a single type are polymerized, or copolymer in which monomers of two or more than two types are co-polymerized, can be used. In the case of copolymers, either random copolymers or block copolymers can be used. The molecular amount of the polymer in number average molecular weight (Mn) is generally 5,000 to 1,000,000 and preferably 10,000 to 100,000. If the molecular amount is too small, the film strength is insufficient. If the molecular amount is too large, the film-formability thereof is poor. Such extreme cases are, needless to say, not preferable.

Specific examples of the macropolymer latex which can be used in the present invention include the followings: latexes formed by a copolymer of methyl methacrylate/ethyl acrylate/methacrylic acid; latexes formed by a copolymer of methyl methacrylate/2-ethylhexyl acrylate/styrene/acrylic acid; latexes formed by a copolymer of styrenre/butadiene/acrylic acid; latexes formed by a copolymer of styrene/butadiene/divinylbenzene/methacrylic acid; latexes formed by a copolymer of methyl methacrylate/vinyl chloride/acrylic acid; and latexes formed by a copolymer of vinylidene chloride/ethyl acrylate/acrylonitril/methacrylic acid.

An anti-fading agent may be added to the light absorbing layer. Examples of the anti-fading agent which serves as a stabilizer of a dye include: a hydroquinone derivative (U.S. Pat. No. 3,935,016 and U.S. Pat. No. 3,982,944); a hydroquinone diether derivative (U.S. Pat. No. 4,254,216 and JP-A-55-21004); a phenol derivative (JP-A-54-145530); a spiroindane or methylenedioxybenzene derivative (U.K. patent publication Nos. 2,077,455 and 2,062,888, JP-A-61-90155); chroman, spirochroman or coumarane derivative (U.S. Pat. No. 3,432,300, No. 3,573,050, No. 3,574,627, No. 3,764,337, JP-A-52-152225, JP-A-53-20327, JP-A-53-17729, JP-A-61-90156); a hydroquinone monoether or para-aminophenol derivative (U.K. patent Nos. 1,347,556 and 2,066,975, JP-B-54-12337 (“JP-B” means examined Japanese patent publication), JP-A-55-6321); and a bisphenol derivative (U.S. Pat. No. 3,700,455 and JP-B-48-31625).

In order to enhance the stability of the dye against light or heat, a metal complex, such as those disclosed in U.S. Pat. No. 4,245,018 and JP-A-60-97358, may be used as the anti-fading agent.

Further, in order to improve lightfastness of a dye, a singlet oxygen quencher may be used as an anti-fading agent. Examples of the singlet oxygen quencher include a nitroso compound (disclosed in JP-A-2-300288), a diimmonium compound (disclosed in U.S. Pat. No. 465,612), a nickel complex (disclosed in JP-A-4-146189) and an antioxidant (disclosed in European patent publication No. 820,057 A1).

Preferable examples of the material to form a transparent support (base) for use in the present invention include cellulose esters (e.g., cellulose diacetate, cellulose triacetate, cellulose propionate, cellulose butylate, cellulose acetate propionate, cellulose nitrate), polyamides, polycarbonates, polyesters (e.g., poly(ethylene terephthalate), poly(ethylene naphthalate), poly(butylene terephthalate), poly-1,4-cyclohexanedimethylene terephthalate, polyethylene-1,2-diphenoxyethane-4,4′-dicarboxylate), polystyrenes (e.g., syndiotactic polystyrene), polyorefins (e.g., polyethylene, polypropylene, polymethylpentene), poly(meth)acrylate (e.g., poly(methyl methacrylate)), polysulfones, polyethersulfones, polyetherketones, polyetherimides and polyoxyethylenes. More preferable examples thereof include cellulose triacetate, polycarbonate, poly(methyl methacrylate), poly(ethylene terephthalate) and poly(ethylene naphthalate).

The transmittance of the transparent support is preferably 80% or more, and more preferably 86% or more. The haze thereof is preferably 2% or less, and more preferably 1% or less. The refractive index is preferably in the range of 1.45 to 1.70.

An infrared-ray absorbing agent or an ultra-violet-ray absorbing agent may be added to the transparent support. The amount of the infrared-ray absorbing agent to be added is preferably 0.01 to 20 wt % of the transparent support, and more preferably 0.05 to 10 wt %. Further, as a lubricant, particles of an inactive inorganic compound may be added to the transparent support. Examples of such an inorganic compound include SiO₂, TiO₂, BaSO₄, CaCO₃, talc and kaoline.

It is preferable that the transparent support is subjected to a surface treatment, in order that the adhesion property between the transparent support and a layer provided thereon (e.g., an undercoat layer) is enhanced. Examples of the surface treatment include a treatment by chemicals, a mechanical treatment, a corona discharge treatment, a flame treatment, a UV radiation treatment, a high-frequency treatment, a glow discharge treatment, an active plasma treatment, a laser treatment, a mixed-acid treatment, and an ozone-oxidation treatment. Among these examples, a glow discharge treatment, a UV radiation treatment, a corona discharge treatment and a flame treatment are preferable, and a corona discharge treatment is further more preferable.

It is preferable that an undercoat layer (a subbing layer) is provided between the transparent support and a layer (e.g. a light-absorbing layer) adjacent thereto.

The undercoat layer is formed as a layer which contains a polymer whose glass transition temperature is 25° C. or less, a layer whose surface on the side of the adjacent layer is a rough (uneven) surface, or a layer which contains a polymer having affinity with the polymer contained in the adjacent layer. Specifically, the undercoat layer may be provided on one surface of the transparent support on which the adjacent layer is not formed, so that adhesion force between the transparent support and the layer provided thereon (e.g., an anti-reflection layer, a hard-coating layer) is improved. Further, the undercoat layer may be provided in order to improve the affinity between the electromagnetic-wave-shielding film and the adhesive agent for adhering the electromagnetic-wave-shielding film to the image forming apparatus.

The thickness of the undercoat layer is preferably in the range of 20 to 1000 nm, and more preferably in the range of 80 to 300 nm.

The undercoat layer, containing a polymer whose glass transition temperature is 25° C. or lower, adheres, by the adhesiveness of the polymer, the transparent support to the adjacent layer. The polymer whose glass transition temperature is 25° C. or lower can be obtained by polymerization or copolymerization of vinyl chloride, vinylidene chloride, vinyl acetate, butadiene, neoprene, styrene, chloroprene, acrylic ester, methacrylic ester, acrylonitril, or methyl vinyl ether. The glass transition temperature is preferably 20° C. or lower, more preferably 15° C. or lower, further preferably 10° C. or lower, still further preferably 5° C. or lower, and most preferably 0° C. or lower.

By forming the adjacent layer on the rough surface of the undercoat layer, the undercoat layer adheres the transparent support to the adjacent layer. The undercoat layer having one rough surface can be easily formed by coating macromolecular latex on the transparent support. The average particle diameter of the latex is preferably in the range of 0.02 to 3 μm, and more preferably in the range of 0.05 to 1 μm.

Examples of the polymer having affinity with the binder polymer contained in the adjacent layer include acrylic resins, cellulose derivatives, gelatin, casein, starch, polyvinyl alcohol, dissolvable polyamides (nylons), and macromolecular latexes.

Two or more than two undercoat layers may be provided.

A solvent for swelling the transparent support, a matt agent, a surfactant, an antistatic agent, a coating-aid, and a film-hardening agent may be added to the undercoat layer.

An anti-reflection layer may be provided on the electromagnetic-wave-shielding film. The reflectance (specular reflectance) of the electromagnetic-wave-shielding film having an anti-reflection layer thereon is preferably 3.0% or less, and more preferably 1.8% or less. As the anti-reflection layer, a layer having a low refractive index (which will be referred to as “a low-refractive-index layer” hereinafter) is generally provided. The low-refractive-index layer has a refractive index lower than that of the layer provided thereunder. The refractive index of the low-refractive-index layer is preferably in the range of 1.20 to 1.55, and more preferably in the range of 1.20 to 1.50. The thickness of the low-refractive-index layer is preferably in the range of 50 to 400 nm, and more preferably in the range of 50 to 200 nm.

Examples of the low-refractive-index layer include: a layer formed by a fluorine-containing polymer having a low refractive index (as disclosed in JP-A-57-34526, JP-A-3-130103, JP-A-6-115023, JP-A-8-313702, JP-A-7-168004); a layer obtained by a sol-gel method (as disclosed in JP-A-5-208811, JP-A-6-299091, JP-A-7-168003); and a layer containing fine particles (as disclosed in JP-B-60-59250, JP-A-5-13021, JP-A-6-56478, JP-A-7-92306, JP-A-9-288201). In the case of the layer containing fine particles, voids can be formed in the low-refractive-index layer, in the form of microvoids among or inside the fine particles. The layer containing the fine particles preferably has the percentage of void in the range of 3 to 50 vol %, and more preferably in the range of 5 to 35 vol %.

In order to effect preventing reflection in a wide range of wavelength band, it is preferable that a layer having a high refractive index (which will be referred to as an “intermediate/high-refractive-index layer” hereinafter) is laminated on the low-refractive-index layer.

The refractive index of the high-refractive-index layer is preferably in the range of 1.65 to 2.40, and more preferably in the range of 1.70 to 2.20. The refractive index of the intermediate-refractive-index layer is adjusted so that the refractive index of the intermediate-refractive-index layer is an intermediate value between the refractive the refractive index of the low-refractive-index layer and that of the high-refractive-index layer. The refractive index of the intermediate-refractive-index layer is preferably in the range of 1.50 to 1.90.

The thickness of the intermediate/high-refractive-index layer is preferably in the range of 5 nm to 100 μm, more preferably in the range of 10 nm to 10 μm, and most preferably in the range of 30 nm to 1 μm.

The haze of the intermediate/high-refractive-index layer is preferably 5% or less, more preferably 3% or less, and most preferably 1% or less.

The intermediate/high-refractive-index layer can be formed by using a polymer having a relatively high refractive index. Examples of the polymer having a relatively high refractive index include a polystyrene, a styrene copolymer, a polycarbonate, a melamine resin, a phenol resin, an epoxy resin, and a polyurethane obtained by the reaction of a cyclic (aliphatic or aromatic) isocyanate with a polyol. In addition, other polymers having a cyclic (aromatic, heterocyclic, aliphatic) group, as well as polymers having a halogen atom other than fluorine as a substituent, have a relatively high refractive index. Polymers may be formed by a polymerization reaction of monomers which have been made capable of radical hardening by the introduction of double bond.

In order to obtain a still higher refractivr index, inorganic fine-particles may be dispersed in the polymer binder. The refractive index of the inorganic fine-particles is preferably in the range of 1.8 to 2.80. It is preferable that the inorganic fine-particles are formed from a metal oxide or a metal sulfide. Examples of the metal oxide or the metal sulfide include titanium dioxide (e.g., rutile, mixed crystals of rutile/anatase, anatase, an amorphous structure), tin oxide, indium oxide, zinc oxide, zirconium oxide and zinc sulfide. Among these examples, titanium oxide, tin oxide and indium oxide are especially preferable. The inorganic fine-particles contain the aforementioned metal oxide or metal sulfide as the main component, and may further contain other elements. Here, “the main component” means a component whose content (wt %) is the largest among the components which constitute the particles. Examples of the other elements include Ti, Zr, Sn, Sb, Cu, Fe, Mn, Pb, Cd, As, Cr, Hg, Zn, Al, Mg, Si, P and S.

Further, the intermediate/high-refractive-index layer can be formed, by using an inorganic material which is either in a liquid state itself or dispersible in a solvent, to form a film when coated. Examples of such an inorganic material include alkoxide of various elements, a salt of an organic acid, a coordination compound bonded with a coordination compound (e.g., a chelate compound), and an active inorganic polymer.

The electromagnetic-wave-shielding film of the present invention, in a preferred form thereof, may have a rough (uneven) surface. The section of the convexed portion of the rough surface preferably has a shape in which slopes gently extend from a rounded vertex (apex) to the outskirts. It is preferable that the slope portion is upwardly convexed in the vicinity of the vertex and downwardly convexed in other portions. The vertex may be either acutely angled or flat. The configuration of the convexed portion in a top view is preferably a circle or an oval, but may be a triangle, a quadrilateral, a hexagon or some other complicated shape. The configuration of the convexed portion is defined by the contour line of the groove portion surrounding the outskirts of the convexed portion. The size of the convexed portion defined by the contour line is, when expressed by a diameter of a circle having an equivalent area corresponding to the portion, preferably in the range of 0.5 to 300 μm, more preferably in the range of 1 to 30 μm, and most preferably in the range of 3 to 20 μm.

Examples of the method of forming a rough surface include: a method of carrying out a calendar pressing with a calendar roll having a rough surface; a method of coating a solution containing the matrix and particles on a support and drying the coating (and optionally hardening the coating), to form a layer; a printing method; a lithography method; and an etching method. Among these examples, the method of coating a solution containing the matrix and the particles on a support is preferable.

The compound to be used for the aforementioned matrix is preferably a polymer having a saturated hydrocarbon or polyether as the main chain, and more preferably a polymer having a saturated hydrocarbon as the main chain. It is preferable that the polymer has been cross-linked. It is preferable that the polymer having a saturated hydrocarbon as the main chain is obtained by the polymerization reaction of ethylenically unsaturated monomers. In order to obtain a cross-linked binder polymer, it is preferable that the monomer having two or more than two ethylenically unsaturated groups is used.

Examples of the monomer having two or more than two ethylenically unsaturated groups include: an ester of a polyvalent alcohol and acrylic/methacrylic acid (e.g., ethylene glycol diacrylate, ethylene glycol dimethacrylate, 1,4-cyclohexanediol diacrylate, pentaerythritol tetraacrylate, penterythritol tetramethacrylate, pentaerythritol triacrylate, penterythritol trimethacrylate, trimethylol propane triacrylate, trimethylol propane trimethacrylate, trimethylol ethane triacrylate, trimethylol ethane trimethacrylate, dipentaerythritol tetraacrylate, dipenterythritol tetramethacrylate, dipentaerythritol pentaacrylate, dipenterythritol pentamethacrylate, pentaerythritol hexaacrylate, penterythritol hexamethacrylate, 1,3,5-cyclohexanetriol triacrylate, polyurethane polyacrylate, polyester polyacrylate); vinylbenzene and derivatives thereof (e.g., 1,4-divinylbenzene, 4-vinylbenzoate-2-acryloylethyl ester, 1,4-divinylcyclohexanone); a vinylsulfone (e.g., divinylsulfone); an acrylamide (e.g., methylenebisacrylamide); and a methacrylamide.

It is preferable that the monomer having the ethylenically unsaturated group is hardened, after being coated, by the polymerization reaction caused by ionizing radiation or heat.

It is preferable that the polymer having polyether as the main chain is synthesized by ring-opening polymerization reaction of a multifunctional epoxy compound.

In place of or in addition to the monomer having two or more than two ethylenically unsaturated groups, a compound having a cross-linkable group may be employed. That is, the cross-linked structure can be introduced into the binder polymer by the reaction of the cross-linkable group, as well. Examples of the cross-linkable group include an isocyanate group, epoxy group, aziridine group, oxazoline group, aldehyde group, carbonyl group, hydrazine group, carboxyl group, methylol group, and active methylene group. Examples of the cross-linkable group further include a vinylsulfone group, acid anhydride, cyanoacrylate derivative, melamine, ethylated methylol, ester bonding and urethane bonding. A metal alkoxide such as tetramethoxysilane can also be used as the monomer for introducing the cross-linked structure. A functional group which exhibits cross-linkable property as a result of a decomposition reaction, such as a block-isocyanate group, may also be used. Further, the cross-linkable group may be a functional group which becomes reactive as a result of decomposition. It is preferable that the cross-linkable compound is subjected to the cross-linking process by heat, after the coating process.

In order to provide roughness with the surface of the electromagnetic-wave-shielding film, inorganic particles or organic particles are employed. Examples of the material to be used for forming said inorganic particles include silicon dioxide, titanium dioxide, magnesium oxide, calcium carbonate, magnesium carbonate, barium sulfate and strontium sulfate. The organic particles are generally formed from a polymer. Examples of the polymer to be used for forming said organic particles include polymethyl acrylate, polymethyl methacrylate, polyacrylonitril, polystyrene, cellulose acetate and cellulose acetate propionate. The organic particles are more preferable than the inorganic particles. Among the aforementioned examples, polymethyl methacrylate or polyethylene particles are especially preferable. The average particle diameter of the particles is preferably in the range of 0.5 to 30 μm, and more preferably in the range of 1 to 3 μm. A combination of particles of two or more than two types of different materials forming said particles, having the same diameter, or a combination of particles of two or more than two types having different diameters, may be used.

The average thickness of the layer having the roughened surface is preferably smaller than the average particle diameter of the particles.

The electromagnetic-wave-shielding film may be provided with a hard coating layer, a lubricating layer, an anti-stain layer, an antistatic layer or an intermediate layer.

The hard coating layer preferably contains a cross-linked polymer. The hard coating layer can be formed by using an acrylic-series, urethane-series, epoxy-series, siloxane-series polymer, oligomer or monomer (e.g., a hardenable-by-UV type resin). A silicon dioxide (silica)-series filler may be added to the hard coating layer.

The lubricating layer may be formed on the anti-reflection layer (which generally corresponds to the low-reflection-index layer) as the uppermost surface. The lubricating layer serves to provide the surface of the anti-reflection layer with the lubricating property and thus improve the scratch-resistance property. The lubricating layer can be formed by using polyorganosiloxane (e.g., silicone oil), natural wax, petroleum wax, a metal salt of higher aliphatic acid, a fluorine-containing lubricant or a derivative thereof. The thickness of the lubricating layer is preferably in the range of 2 to 20 nm.

The anti-stain layer may be provided on the anti-reflection layer as the uppermost surface. The anti-stain layer serves to decrease the surface energy of the anti-reflection layer, so that hydrophilic or oleophilic stains are prevented from attaching to the anti-reflection layer. The anti-stain layer can be formed by using a fluorine-containing polymer. The thickness of the anti-stain layer is preferably in the range of 2 to 100 nm, and more preferably in the range of 5 to 30 nm.

The various layers of the electromagnetic-wave-shielding film described above can be formed by a usual coating method. Examples of the coating method include a dip coating method, air knife coating method, curtain coating method, roller coating method, wire bar coating method, gravure coating method, and extrusion-coating method using a hopper (as disclosed in U.S. Pat. No. 2,681,294). Among the aforementioned examples, the wire bar coating method, the gravure coating method and the extrusion-coating method are preferable.

Two or more than two layers may be formed by the simultaneous coating method. The references which make descriptions of this method include U.S. Pat. No. 2,761,791, No. 2,941,898, No. 3,508,947, No. 3,526,528 and “Coating Engineering” by Yuji Harasaki, page 253, 1973, Asakura Shoten).

Additives such as a polymer binder, a hardening agent, a surfactant and a pH-adjusting agent may be added to the coating solution of each layer.

Examples of the method of forming a layer further include a spattering method, a vacuum deposition method, an ion plating method, a plasma CVD method and a PVD method, in addition to the aforementioned coating methods.

The electromagnetic-wave-shielding film can be used in an image display device such as a liquid crystal display device (LCD), a plasma display panel (PDP), an electroluminescence display (ELD) and a cathode-ray-tube display device (CRT). The electromagnetic-wave-shielding film according to the present invention is significantly effective when the electromagnetic-wave-shielding film is used in a plasma display panel (PDP) or a cathode-ray-tube display device (CRT). The electromagnetic-wave-shielding film of the present invention is most significantly effective when the electromagnetic-wave-shielding film is used in a plasma display panel (PDP).

A plasma display panel (PDP) is generally constituted of a gas, a glass substrate, electrodes, an electrode reed material, a thick film printing material and a fluorescent body. The glass substrate is constituted of two sheets of glass including a front glass substrate and a rear glass substrate. The electrode and an insulating layer are formed on the two (front and rear) glass substrates. Further, a fluorescent body layer is formed on the rear glass substrate. The two (front and rear) glass substrates are assembled and a gas is enclosed therebetween.

A plasma display panel (PDP) has already been commercially available. JP-A-5-205643 and JP-A-9-306366 disclose such a plasma display panel.

A front panel may be provided on the front side of the plasma display panel. The front panel preferably has mechanical strength which is large enough to protect the plasma display panel. The front panel may be provided on the plasma display panel with an interval therebetween, or may be mounted directly on the plasma display main body.

In an image display device such as a plasma display panel, the electromagnetic-wave-shielding film (optical filter) is mounted on the display surface. Specifically, the electromagnetic-wave-shielding film can be mounted directly on the surface of the display. In a case in which a front panel is provided in front of the display, the electromagnetic-wave-shielding film can be mounted on the exterior surface (facing the outside) or the rear surface (facing the display) of the front panel.

In the present invention, examples of the method of incorporating the mesh film composed of a metal thin film into the laminated layer film include: a method of first forming a mesh film composed of a metal thin film on a transparent support and then providing a dye layer, an anti-reflection layer or the like thereon; and a method of first providing a dye layer, an anti-reflection layer or the like on a transparent support, providing an adhesive layer on a mesh film composed of a metal thin film formed on another support, and laminating the transparent support and the another support. In terms of enhancing the producability, the latter laminating method is preferable.

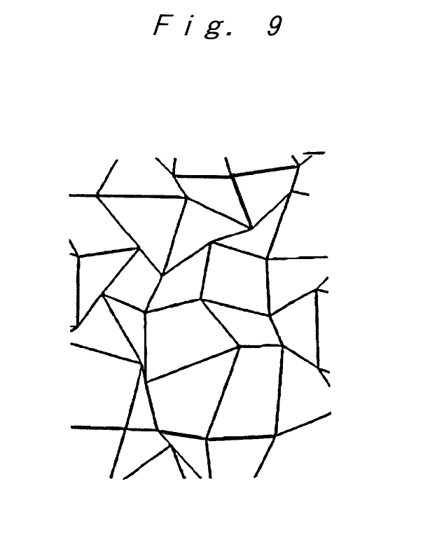

One example of a preferred embodiment of the electromagnetic-wave-shielding film of the present invention, which has the aforementioned structure, is shown in a sectional view in FIG. 8.

Some other preferable embodiments in the preferable invention include the following means:

(i) An optical filter, comprising an electromagnetic-wave-shielding film having a transparent support and a mesh film, the mesh film being formed by a metal thin film and having random mesh portions; and

(ii) A plasma display panel, which comprises:

an optical filter that comprises an electromagnetic-wave-shielding film, the film having a transparent support and a mesh film formed by a metal thin film, and

a plasma display,

wherein the optical filter is mounted (preferably mounted directly) on the plasma display.

According to the electromagnetic-wave-shielding film (the optical filter) of the present invention, the intensity of the electromagnetic wave and infrared ray radiated from the image display device can be decreased, the color purity can be improved, and the occurrence of moire can be prevented.

According to the method of producing the electromagnetic-wave-shielding transparent film of the present invention, the aforementioned electromagnetic-wave-shielding film which exhibits excellent performances can be efficiently produced.

Further, the image display device, such as the plasma display panel, of the present invention can be produced by mounting, by using an adhesive or the like, the aforementioned electromagnetic-wave-shielding film on the display of the image display device, thereby the image display device of the invention is excellent in that the intensity of the electromagnetic wave and infrared ray radiated from the image display device can be decreased, that the color purity can be improved, and that the occurrence of moire can be prevented.

The present invention will be described in more detail on the basis of the following examples, but the invention is not limited to these.

### EXAMPLE

### Example 1-1

(Formation of a Mesh Film Composed of a Metal Thin Film)

A copper foil film having film thickness of 2 μm was produced, on a transparent biaxially-stretched polyethylene terephthalate film having thickness of 175 μm, by electroless plating, in the same manner as in JP-A-9-293989. A photoresist was provided on the copper foil by spin coating, to form a photomask, and the resultant support with said photoresist was then subjected to contact exposure and development, using the photomask. The metal layer of the portions which were not covered by the photoresist was removed by etching with diluted (1%) nitric acid. As a result, a mesh film, as shown in FIG. 1, composed of a copper thin film, in which copper lines having line width of 12 μm were arranged in a lattice-like pattern such that the interval between the lines was 250 μm, was produced.

(Formation of the Undercoat Layer)

Both surfaces of a transparent biaxially-stretched polyethylene terephthalate film having thickness of 175 μm were subjected to corona processing. Thereafter, a latex composed of styrene-butadiene copolymer having a refractive index of 1.55 and a glass transition temperature of 37° C. (LX407C5, trade name, manufactured by Nippon Zeon Co., Ltd.) was coated on both surfaces of the polyethylene terephthalate film, thereby an undercoat layer for an anti-reflection layer and a visible-light absorbing layer described below was formed. The amount of coating was adjusted so that the thickness of the coating layer provided on one surface (Surface A) of the transparent support (after drying) was 300 nm and the thickness of the coating layer provided on the other surface (Surface B) of the transparent support (after drying) was 150 nm.

(Formation of the Visible-light Absorbing Layer)

The pH value of 180 g of a 10 wt % styrene-butadiene latex solution was adjusted to be pH 7 by adding a sodium hydroxide solution (0.001 mol/m³). Then, 0.07 g of Dye (1) was added to the resultant mixture, and the resultant mixture was stirred for 3 hours at 30° C. The thus-obtained solution was coated on the Surface A side of the aforementioned undercoat layer such that the thickness of the film after drying was 2.1 μm. The coating was dried at 120° C. for 2 minutes, thereby the visible-light absorbing layer was formed. The wavelength of the maximum absorption by the visible-light absorbing layer was 593 nm.

Dye (1)

[chemical structure]

(Formation of the Anti-reflection Layer)

1.5 g of t-butanol was added to 2.50 g of a reactive fluoropolymer (JN-7219, trade name, manufactured by JSR Co.) and the resultant mixture was stirred at room temperature for 10 minutes. The resulting solution was filtered by a polypropylene filter of 1 μm, thereby a coating solution for the anti-reflection layer was prepared. The coating solution was coated on the surface opposite to the surface on which the visible-light absorbing layer was formed (i.e. on the Surface B side) by using a bar coater so that the thickness of the coated film after being dried was 90 μm. The coating was dried at 120° C. for 3 minutes, to form the anti-reflection layer.

The portion (A) including the transparent support and the laminated layer film having the aforementioned anti-reflection layer was laminated with the portion (B) including the mesh film composed of the metal thin film (which portion (B) had been coated with an acryl-series adhesive), thereby an electromagnetic-wave-shielding film (optical filter) was produced.

The thus-obtained electromagnetic-wave-shielding film was mounted on a plasma display having pixels of 0.735 mm size, and it was evaluated. The electromagnetic-wave-shielding film mounted on the plasma display was in the state corresponding to that as shown in FIG. 8.

### Examples 1-2 to 1-4, Comparative Examples 1-1 to 1-2

The line width, the line intervals of the mesh film composed of a metal thin film in Example 1, and the film thickness of the layer(s), were set as shown in Table 1, and the resultant electromagnetic-wave-shielding films of each example and comparative example were evaluated on a display having pixels as shown in Table 1.

(Evaluation of the Electromagnetic-wave-shielding Film)

The surface resistance on the side of the mesh film composed of a metal thin film of the electromagnetic-wave-shielding film was measured using a four-terminal sensor of “LORESTA-FP” surface resistance meter, trade name, manufactured by Mitsubishi Yuka Co., Ltd. All the values of the measured surface resistance were 0.5 Ω/□, which are resistance small enough for the purpose of blocking electromagnetic waves.

Moire was evaluated by removing the front panel of the plasma display panel and mounting the electromagnetic-wave-shielding film directly on the panel. The case in which moire was hardly observed was designated as “∘”, the case in which moire was slightly observed was designated as “Δ”, and the case in which moire was significantly observed was designated as “×”.

Improvement (enhancement) in colors was tested and evaluated by the naked eye. The case when improvement in colors was recognized it is designated to “∘”, and the case when improvement in colors was not recognized it is designated to “×”.

TABLE 1

| | | | | | Interval | | | | |
|---|---|---|---|---|---|---|---|---|---|
| | | | Interval | Area | between | | | | |
| | Line | Pixel | between | defined | lines/ | | | | Effect on |
| | width | pitch | lines | by lines/ | pixel | Shape of unit | No. of dye | | improvement |
| | (μm) | (mm) | (mm) | pixel area | pitch | area | compound | Moire | of color |
| Example 1-1 | 12 | 0.735 | 0.25 | 0.116 | 0.340 | Square | (1) | Δ | ∘ |
| Example 1-2 | 12 | 1.08 | — | 0.061 | — | Quadrilateral | (1) | ∘ | ∘ |
| Example 1-3 | 8 | 1.08 | 0.2 | 0.078 | 0.185 | Rectangle (the | (1) | ∘ | ∘ |
| | | | | | | other side 0.18) | | | |
| Example 1-4 | 5 | 0.39 | 0.05 | 0.016 | 0.128 | Square | (1) | ∘ | ∘ |
| Comparative | 8 | 0.39 | 0.25 | 0.411 | 0.641 | Square | (1) | X | X |
| example 1-1 | | | | | | | | | |
| Comparative | 18 | 1.03 | 0.8 | 0.603 | 0.777 | Square | None | X | X |
| example 1-2 | | | | | | | | | |

As is apparent from the results shown in Table 1, the examples according to the present invention are apparently excellent in moire and improvement in colors.

### Example 2-1

(Production of a Random Mesh Pattern)

A random mesh pattern was produced, by shifting each intersecting point (by shifting each lattice line) of a lattice-like pattern having line width of 7 μm and interval between the lines of 250 μm, within the range defined by linking the middle points each located half in the distance between an individual intersecting point and the adjacent points thereof. The thus-obtained random mesh pattern was used as a photomask. The random mesh pattern of the photomask is shown in FIG. 9.

(Formation of a Mesh Film Composed of a Metal Thin Film)

In the same manner as in JP-A-9-293989, a copper foil film having film thickness of 2 μm was prepared, by electroless plating, on a transparent biaxially-oriented polyethylene terephthalate film having thickness of 175 μm. A photoresist was provided on the copper foil by spin coating, to prepare a photomask. The resultant support with photoresist was then subjected to contact exposure and development, using the aforementioned photomask. The metal layer of the portions which had not been covered by the resist was removed by etching with 1% diluted nitric acid, thereby a mesh film composed of a copper thin film, in which copper lines were arranged at random, was obtained.

In the same manner as described above in Example 2-1, a mesh film was prepared, provided that the intersecting points of copper lines were arranged at random within a range defined by linking the points each located, from an individual intersecting point, one-third of the distance between said individual intersecting point and the adjacent points thereof (Example 2-2). Further, in the same manner as in Example 2-1, a mesh film was prepared, provided that the intersecting points of copper lines were arranged at random within a range defined by linking the points each located, from an individual intersecting point, four-fifths of the distance between the intersecting point and the adjacent points thereof (Example 2-3).

The surface resistance of each mesh film was measured by using a four-terminal sensor of LORESTA-FP surface resistance meter, trade name, manufactured by Mitsubishi Yuka Co., Ltd. Each of the measured surface resistance values of the films was 0.5 Ω/□, which demonstrated that all the films had resistance low enough for preventing electromagnetic wave.

Each of the thus-produced mesh film was mounted on a plasma display, and the outer appearance and the state of occurrence of moire were observed.

The results are shown in Table 2.

### Comparative Example 2-1

A lattice-like mesh film having line width of 7 μm and interval between the lines of 250 μm was produced. The thus-produced mesh film was mounted on a plasma display, and the outer appearance and the state of occurrence of moire were observed.

The results are shown in Table 2.

In the table, the degree of moire occurrence was designated as follows: “∘” (hardly occured); “Δ” (slightly occurred); and “×” (significantly occurred).

TABLE 2

| | Outer | |
|---|---|---|
| | appearance | |
| | (unevenness in | |
| | shading) | Occurrence of moire |
| Example 2-1 | No problem | ◯ |
| Example 2-2 | No problem | ◯ |
| Example 2-3 | No problem | ◯ |
| Comparative | No problem | X |
| example 2-1 | | |

### Example 2-4

By using the mesh film composed of the metal thin film prepared in Example 2-1, a film having a visible-light absorbing layer, an infrared-ray absorbing layer, an anti-reflection layer, and the like was produced.

(Formation of Undercoat Layers)

The undercoat layers were provided in the same manner as in Example 1-1.

(Formation of a Visible-light Absorbing Layer and Infrared-ray Absorbing Layer)

The pH value of 180 g of 10 wt % aqueous solution of gelatin was adjusted to be pH 7 by adding a sodium hydroxide solution (1N). Were added thereto, 15 mg/m² of Dye (1), 24.5 mg/m² of Compound 2-7, 45.9 mg/m² Compound 1-12, 29.1 mg/m² of Compound 1-13, and 120 mg/m² of Dye (2), and the resultant mixture was stirred for 24 hours at 30° C. The thus-obtained coating solution for the filter layer was coated on the Surface (A) side of undercoat layer having thickness of 300 nm on the transparent support, such that the film thickness of the coating after drying was 3.5 μm. The resultant coating was dried at 120° C. for 10 minutes, thereby a filter layer was produced.

[chemical structure]

(Formation of an Anti-reflection Layer)

1.5 g of t-butanol was added to 2.50 g of a reactive fluoropolymer (JN-7219, trade name, manufactured by JSR Co.) and the resultant mixture was stirred at room temperature for 10 minutes. The resulting solution was filtered by a polypropylene filter of 1 μm, thereby a coating solution for the anti-reflection layer was prepared. The coating solution was coated on the surface opposite to the surface on which the visible-light absorbing layer and the metal-line layer were formed (on the Surface B side) by using a bar coater so that the thickness of the film after being dried was 90 μm. The resultant coating was dried at 120° C. for 3 minutes.

The portion (A) including the transparent support and the laminated layer film having the aforementioned anti-reflection layer was laminated with the portion (B) including the mesh film composed of the metal thin film (which portion (B) had been coated with an acryl-series adhesive), thereby an electromagnetic-wave-shielding film was produced.

The spectral transmittance of the electromagnetic-wave-shielding film produced in the aforementioned manner was measured. The electromagnetic-wave-shielding film exhibited the maximum absorption at 400 nm, 593 nm, 810 nm, 904 nm and 985 nm. The transmittance at the maximum absorption of 400 nm was 35%, the transmittance at the maximum absorption of 593 nm was 30%, the transmittance at the maximum absorption of 810 nm was 5%, the transmittance at the maximum absorption of 905 nm was 1%, and the transmittance at the maximum absorption of 983 nm was 3%.

The electromagnetic-wave-shielding film having the transparent conductive film of the present invention was mounted directly on a plasma display, or on the inner surface of the front panel of the plasma display panel. Then, the external appearance and the state of moire occurrence were observed. No problematic uneveness in shading (light-to-dark contrast) or moire was observed. It was observed that the colors had been significantly improved, that the transmittance of the electromagnetic-wave-shielding film in the range of 800 to 900 nm was 10% or less, and that the electromagnetic-wave-shielding film had the excellent electromagnetic-wave-preventing property.

Having described our invention as related to the present embodiments, it is our intention that the invention not be limited by any of the details of the description, unless otherwise specified, but rather be construed broadly within its spirit and scope as set out in the accompanying claims.

What we claim is:

1. An electromagnetic-wave-shielding film, having a transparent support and a conductive layer composed of a metal thin film, wherein the conductive layer is composed of a mesh film in which random mesh portions are formed.

2. The electromagnetic-wave-shielding film as claimed in claim 1, wherein a shape of the random mesh portions formed in the conductor layer is formed by intersecting points obtainable by shifting lattice lines of a regular lattice pattern from the original position thereof.

3. The electromagnetic-wave-shielding film as claimed in claim 2, wherein a range within which the intersecting points of the lattice lines of the random mesh pattern are arranged, is located within an area defined by linking middle points between an individual intersecting point and each adjacent point thereof of the regular lattice pattern before shifting the lattice lines.

4. The electromagnetic-wave-shielding film as claimed in claim 1, wherein the mesh film formed by the metal thin film is formed by etching according to a photolithography method.

5. The electromagnetic-wave-shielding film as claimed in claim 1, whose lines which form the random mesh shape each have a width of 15 μm or less.

6. The electromagnetic-wave-shielding film as claimed in claim 1, whose lines which form the random mesh shape each have a thickness in the range of 0.1 to 10 μm

7. The electromagnetic-wave-shielding film as claimed in claim 1, wherein a unit space area of the mesh formed by the metal thin film is two fifths or less of a pixel area of an image display device.

8. The electromagnetic-wave-shielding film as claimed in claim 1, whose surface is being subjected to blackening.

9. The electromagnetic-wave-shielding film as claimed in claim 1, in which an infrared-ray cutting layer containing a dye that absorbs light in an infrared-ray range, is formed.

10. The electromagnetic-wave-shielding film as claimed in claim 9, in which a visible-light absorbing layer containing a dye that absorbs light in a visible-light range is formed.

11. A method of producing an electromagnetic-wave-shielding film having a transparent support and a conductive layer composed of a metal thin film, comprising the step of:
forming the conductive layer by using a mesh film in which random mesh portions are formed.

12. The method as claimed in claim 11, comprising forming the random mesh portions to be formed in the conductive layer, by using a shape formed by intersecting points obtainable by shifting lattice lines of a regular lattice pattern from the original position thereof.

13. The method as claimed in claim 11, comprising forming the mesh film formed by the metal thin film, by electroless plating.

14. The method as claimed in claim 11, comprising forming the mesh film formed by the metal thin film, by etching according to a photolithography method.

15. An image display device, wherein an electromagnetic-wave-shielding film, having a transparent support and a conductive layer composed of a metal thin film, is mounted on a front surface of the device, the conductive layer being composed of a mesh film in which random mesh portions are formed.

16. The image display device as claimed in claim 15, wherein the electromagnetic-wave-shielding film mounted on the front surface, has a unit space area of the mesh formed by the metal thin film of two fifths or less of a pixel area of the image display device, and has the random mesh portions in the conductive layer, which are formed by intersecting points obtainable by shifting lattice lines of a regular lattice pattern from the original position thereof.

17. The image display device as claimed in claim 15, wherein the electromagnetic-wave-shielding film mounted on the front surface, has an infrared-ray cutting layer containing a dye that absorbs light in an infrared-ray range, in the film.

18. The image display device as claimed in claim 15, which is a plasma display panel, wherein the electromagnetic-wave-shielding film is mounted on the front surface thereof.
